(19) United States
(12) Patent Application Publication
(10) Pub. No.: US 2018/0308607 A1
(43) Pub. Date: Oct. 25, 2018

(54) PROPERTIES OF TRANSPARENT CONDUCTIVE OXIDES VIA LASER ANNEALING

(71) Applicant: ARIZONA BOARD OF REGENTS ON BEHALF OF ARIZONA STATE UNIVERSITY, Scottsdale, AZ (US)

(72) Inventors: Terry Alford, Phoenix, AZ (US); Sharvanti Pinglay, San Diego, CA (US)

(21) Appl. No.: 15/954,336

(22) Filed: Apr. 16, 2018

Related U.S. Application Data
(60) Provisional application No. 62/486,186, filed on Apr. 17, 2017.

(51) Int. Cl. H01B 13/00; H01B 1/08

(52) U.S. Cl. CPC H01B 13/003; H01B 13/0016; H01B 1/08

(57) ABSTRACT

A method for modifying an electrical characteristic of a transparent conductive oxide (TCO) material. Material is exposed to chosen ambient conditions (including presence of one of forming gas, air, and vacuum) and irradiating with laser radiation under pre-determined conditions. As a result of irradiating, an annealed TCO is formed having a surface characterized by at least one of i) a root-mean-square roughness of 4.5 nm or lower; ii) a grain size of 8.5 nm or greater, and iii) a sheet resistance value of 2.59 Ohms per square or lower. The process of irradiating includes formation of an annealed TCO material in absence of ablating such material.

### CROSS-REFERENCE TO RELATED APPLICATIONS

This patent application claims priority from and benefit of the U.S. Provisional Patent Application No. 62/486,186 filed on Apr. 17, 2017, the disclosure of which is incorporated by reference herein.

### RELATED ART

Indium tin oxide (ITO) films have high optical transmittance in the visible spectral region due to the wide band gap of the ITO (of about 3.5 eV), ability to concentrate electrical carriers, chemical stability, good adhesion properties (that become operationally advantageous during the deposition of ITO on chosen substrates), low electrical resistivity, and desired photochemical properties. These properties make ITO a widely-used material for formation of electrically-conducting elements (such as electrodes, for example) in optoelectronic devices. The preferred use of ITO to form electrically-conducting elements begs a question of improving its electrical characteristics and, in particular, increasing its conductivity.

One possible approach to varying the electrical conductivity (and, accordingly, electrical resistivity) of the ITO material is to expose it to heat. While heat treatments such as microwave-based annealing, used in the past, quite possibly can produce some effect on the electrical, optical and structural morphology of the ITO thin-films, the data describing the results of annealing of the ITO thin-films with microwaves remain inconsistent and inconclusive at best, at least because the ways to controlling the direction of the flow of microwaves remain not well defined, uncertain, causing the results of microwave annealing to be unpredictable.

Implementations of this invention aim at increase of the conductivity (and hence reducing the resistivity) of the ITO films by subjecting them to laser annealing.

### SUMMARY

Transparent conductive oxide (TCO) materials play a significant role in opto-electronic industry. Achieving high conductivity of the TCO materials while maintaining their high optical transmittance remains an unfulfilled industrial need. Embodiments of the invention provide a method for modifying an electrical characteristic of a transparent conductive oxide (TCO) material. Such method includes exposing said material to chosen ambient conditions; and irradiating said material with laser radiation under pre-determined conditions, where the chosen ambient conditions include presence of one of forming gas, air, and vacuum. As a result of said irradiating, an annealed TCO is formed having a surface characterized by at least one of i) a root-mean-square roughness of 4.5 nm or lower; ii) a grain size of 8.5 nm or greater, and iii) a sheet resistance value of 2.59 Ohms per square or lower. The process of irradiating includes formation of an annealed TCO material in absence of ablating such material.

### BRIEF DESCRIPTION OF THE DRAWINGS

The invention will be more fully understood by referring to the following Detailed Description of Specific Embodiments in conjunction with the Drawings, of which:

FIG. 1 is a schematic diagram illustrating a 4-point probe methodology of measuring a sheet resistance of a target sample;

FIG. 2 illustrates the use of a UV-visible spectrophotometer for measuring an optical transmittance of a target sample;

FIGS. 3A, 3B, and 3C illustrate empirically-determined electrical properties of the microwave-annealed samples;

FIGS. 4A, 4B, and 4C are curves representing optical transmittance of the samples characterized in FIGS. 3A, 3B, 3C.

FIG. 5 illustrates sheet resistance values of TCO samples annealed under itemized conditions;

FIG. 6 includes plots representing optical transmittance of the same TCO material layer(s) of interest characterized in FIG. 5;

FIGS. 7A, 7B illustrate the variations of the Haacker figure-of-merit and Fraser-Cook figure-of-merit empirically-defined for microwave-annealed TCO samples;

FIGS. 8A, 8B illustrate the variations of the Haacker figure-of-merit and Fraser-Cook figure-of-merit empirically-defined for laser-annealed TCO samples;

FIGS. 9A, 9B, 9C are optical images showing the surfaces of the TCO samples annealed with exposure to laser radiation and providing evidence of lack of ablation caused by laser annealing;

FIGS. 10A, 10B are images illustrating ablation effects produced by microwave annealing of the TCO samples;

FIGS. 11A, 11B are an AFM image showing the surface morphology of the TCO sample laser-annealed in atmosphere of forming gas, and a curve representing surface profile of such sample;

FIGS. 11C, 11D are an AFM image showing the surface morphology of the TCO sample laser-annealed in the ambient air atmosphere, and a curve representing surface profile of such sample;

FIGS. 11E, 11F are an AFM image showing the surface morphology of the TCO sample laser-annealed in vacuum, and a curve representing surface profile of such sample;

FIG. 11G is an AFM image showing the surface morphology of the not-annealed TCO sample;

FIGS. 12A, 12B provide results of XRD analysis of the material layer of interest;

FIG. 13 illustrates a change in sheet resistance value of an ITO sample as a result of microwave annealing.

Generally, the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

Transparent conductive oxides (TCOs) are commonly used in optical and electronic devices such as solar cell modules, displays (including touch screen displays), and various emissive devices (such as light emitting diodes and organic light emitting diodes). Such opto-electronic devices can be formed on a variety of different substrates such as glass substrates, substrates made of flexible materials including polyimide, polyethylene-naphthalate (PEN), PET, and other materials known to one of ordinary skill in the art, including semiconductor substrates. (The alternative use of metals for formation of electrodes or electrically-conducting layers of the opto-electronic devices may not be preferred because metals, while being highly conductive, have very low transparency in the visible/near-IR region of the optical spectrum even at very low thicknesses. Similarly, highly-transparent materials such as glasses are very poor electrical conductors.)

To enhance the operational properties of a thin-film of a TCO, deposited onto an appropriate substrate, for example provide for a combination of high optical transmittance and low resistivity at the same time, an annealing step may be required. The terms “thin film” and “thin optical film”, used below interchangeably, refer to and define a film of an optical material having such thickness that optical interference effects, caused by multiple reflections of light at a given wavelength within such film, is not considered to occur, at least in the field of physical optics. The term “annealing of a material”, unless expressly specified otherwise, refers to and is defined as heat treatment of the material that alters the physical and sometimes chemical properties of the material to make it more workable for intended purpose. The term “ablation of a material”, unless expressly specified otherwise, refers to and is defined as removal of material from the surface of an object by vaporization, chipping, or other erosive processes caused as a result of a specified treatment of the material. Sheet resistance is a well-recognized measure of resistance of a thin film that is nominally uniform in thickness. Sheet resistance is applicable to two-dimensional systems in which thin films are considered two-dimensional entities. When the term “sheet resistance” is used, it is implied that the current is directed along the plane of the sheet, not perpendicular to it.

Generally speaking, post-deposition annealing treatment may affect the thin-film in several ways: by changing the crystalline property and grain size of the film; by influencing the optical band-gap of the thin-film materials due to the reduction of crystal defects; by improving the optical transmission characteristics and reducing the refractive index of the materials; and by improving the mechanical characteristics such as, for example, reducing the roughness of the thin-film surface.

Conventionally-used annealing methods include the so-called “rapid thermal annealing” or RTA or furnace annealing, performed with light at visible wavelengths, typically characterized by fast heating of the target material (which may be adjusted), slow cooling-down stage, heating of the surface of the target material and growth and/or recrystallization of the solid phase of the target material.

Properties of some of the chosen substrates require low temperature processing is required so as not to damage the substrate materials and any underlying device materials that have been deposited on the substrate in order to form a complete electronic, optical, and/or optoelectronic circuitry. In comparison with a furnace-based annealing procedure, microwave annealing is a technique that is characterized by fast heating and slow cooling rates, causes the volumetric heating of the target material while allowing for a reduced level heating at the material surface and not demanding high temperatures that can affect the entire device structure as well as the device substrate, and is associated with the solid phase growth. The microwave annealing mechanism manifests in dielectric heating, caused by the lag between the dipole polarization (reorientation of the polar molecules along the applied microwave field) and the intermolecular collision. Microwave annealing is recognized to produce a substantially uniform heating in a homogeneous sample, which may not be the case when the sample is not homogeneous.

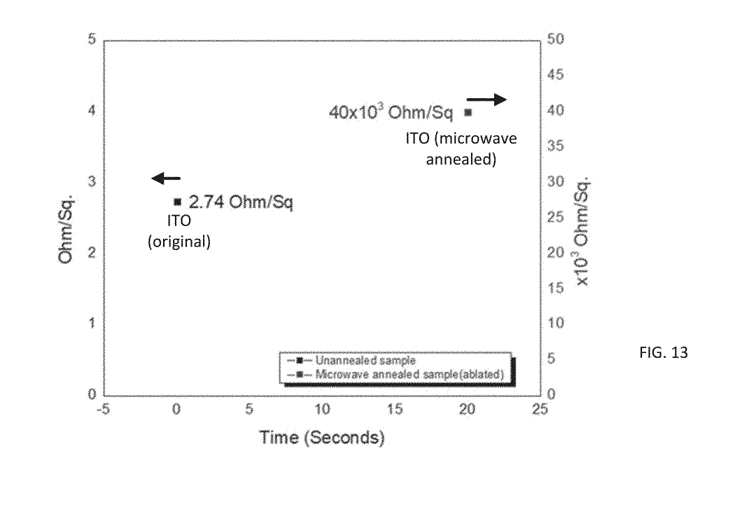

It has been observed, however, that microwave annealing of a TCO material can lead to ablation of the material (which ablation may accompany or even substitute the annealing itself). To this end, FIG. 13 provides a schematic illustration of the difference between the sheet resistance value of an un-annealed (that is, original) layer of ITO deposited on a quartz substrate and that of a microwave annealed/ablated ITO layer. A typical value of sheet resistance (Rₛₕ) of about 2.74 Ω/Sq is seen to increase by about 2000 times to approximately 40 k Ω/Sq as a result of ablation caused by annealing for a period of greater than about 20 seconds (this value maybe be attributed to the quartz substrate below the ITO layer). The ablation, caused as a result of microwave-based annealing process, is undesirable, because the ablated film is rendered to be substantially spatially non-continuous and at least for this reason possessing high value of sheet resistance. A person of ordinary skill in the art will readily recognize that the device fabrication is not practical (if at all possible) with the use of the non-continuous layer or ablated film. Accordingly, there remains a need in an alternative TCO-processing technique.

According to the idea of the invention, laser annealing of a material layer formed as a result of a deposition of a TCO (such as Indium Tin Oxide, Indium Gallium Zinc Oxide, or Indium Zinc Oxide, to name just a few) on a chosen substrate is employed to produce a TCO layer possessing not only high optical transparency but also low resistivity (or sheet resistance). The problem of TCO-surface ablation, accompanying the microwave annealing of a TCO layer, is solved as a result of the application of a method of the invention.

Examples of Sample Treatment and Measurement.

In one embodiment, samples were formed with a layer of Indium Tin Oxide (ITO, at about 30 nm in thickness), deposited onto an approximately 1 micron-thick glass substrate using RF magnetron sputtering. These samples then were subjected to either microwave annealing or to laser annealing in different environments including ambient (air), vacuum, and forming gas atmospheres using a fiber laser producing a pulsed light-output. The forming gas included a mixture of nitrogen and hydrogen, with the hydrogen content ranging, in different cases, from about 0.01% to about 20% (and, in a specific embodiment, with hydrogen comprising about 5% of the mixture). To ensure the surrounding environment, the ITO-overcoated substrate was disposed in an aluminum chamber (with a quartz window), providing for the inlet of different gases.

The microwave annealing was carried out in a single-frequency 2.45 GHz, 2.8104 cm³ cavity applicator microwave system equipped with a 1300 W magnetron source. A Raytek Compact MID series pyrometer with a spectral response in the range of 8-14 micrometers was used to monitor the near surface temperature using an estimated emissivity of 0.7.

In the case of laser annealing, the used laser source was a PLS6MW 40-Watt fiber laser, configured to generate a pulsed 1.06 μm output (in one case—at a frequency of about 500 kHz, thereby providing pulses with energy of about 0.08 mJ), which was focused with a lens system (focal length of about 6.23 cm) into an about 96 micron diameter focal spot. With the so-focused beam, the surface of the ITO layer was irradiated, in a raster fashion, with a density of about 788 lines/cm. The speed, power and area of the sample (of about 1 cm×1 cm) were used as inputs to the program code run on a programmable processor, so the time to anneal the sample was calculated accordingly and maintained at 270 seconds at raster speed of 100% and Power of 30%. The laser-annealing-based heating mechanism turns on conduction losses in the target material, caused by collision between the electron, excited with the absorbed light, and other material species.

The samples were placed on/backed-up with a thick masking tape, while in the processing area, to prevent/eliminate back-reflection of irradiating light from the aluminum portion of the chamber. Once the ITO samples were laser-annealed, they were analyzed under the Olympus DSX500 optical microscope, to confirm the results of annealing and to verify whether any ablation of the ITO layer took place. It was also empirically confirmed that patterns on the samples and the ITO layer were not delaminated.

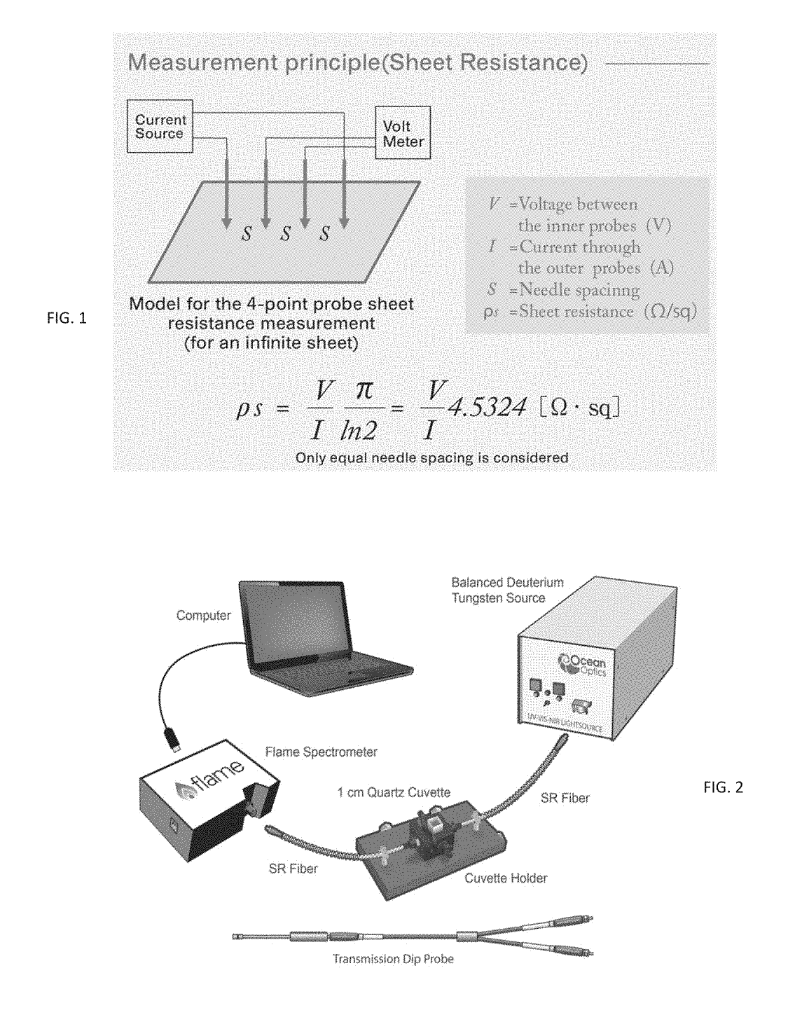

The electrical properties of a given annealed sample were measured with the 4-probe technique to identify the sheet resistance value, as schematically illustrated in FIG. 1. Measurements of optical transmittance were performed with the use of UV-Visible spectrophotometer, see FIG. 2. Additional characterization of the samples was performed with the use of X-ray diffraction and atomic-force microscopy (AFM) in a tapping mode. When characterizing the surface morphology with AFM, additional characterization of the surface roughness was performed by assessing the root-mean-square roughness Rᵣₘₛ of the surface according to the standard deviation of the values of the height of the surface, Z, as

$${R}_{rms} = \sqrt{{\sum }_{n = 1}^{N} \frac{1}{N} {( {Z}_{n} - \overline{Z} )}^{2}} \qquad ( 1 )$$

where Z̅ was the mean value of the surface height and N was the number of measurement points at the surface area.

Modification of Electrical and Optical Properties of Differently Annealed TCO Samples.

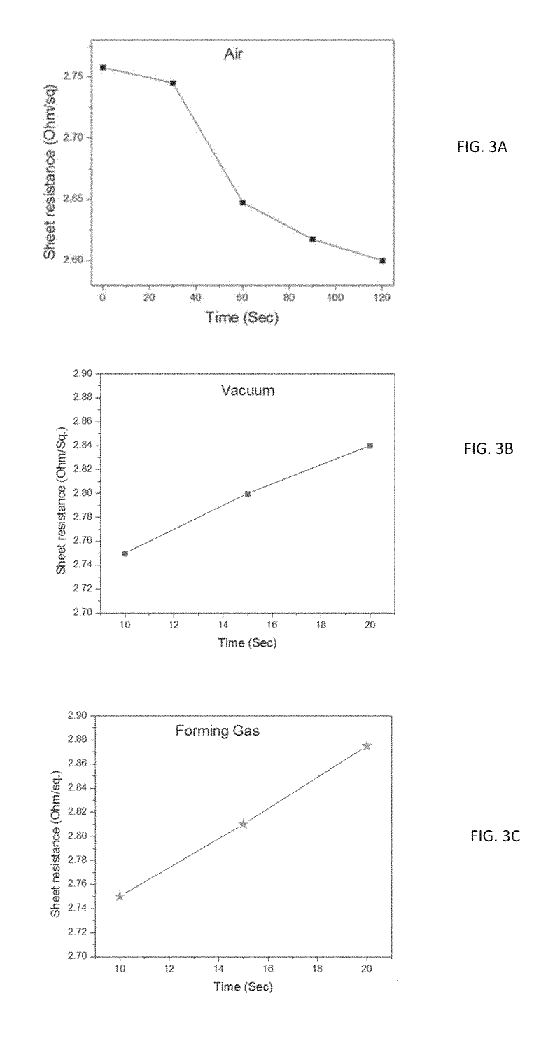

Electrical properties of the microwave-annealed samples are presented in FIGS. 3A, 3B, 3C. Here, the sheet resistance of the ITO samples in three different environments was measured. FIG. 3A shows a decrease in the sheet resistance value from about 2.77 Ω/sq to about 2.59 Ω/sq with time. Here, the ITO samples were subjected to microwaves directly and the samples were heated up to 120 seconds in ambient air atmosphere. FIGS. 3B, 3C show an increase in the sheet resistance value, from about 2.75 Ω/sq to about 2.85 Ω/sq, with increase in time under vacuum, and from about 2.75 Ω/sq to about 2.88 Ω/sq in forming gas. Under both vacuum and forming gas conditions, microwave annealing beyond about 20 seconds was shown to be impractical, as sparks induced inside the glass ampules containing the samples were causing the ablation of the samples.

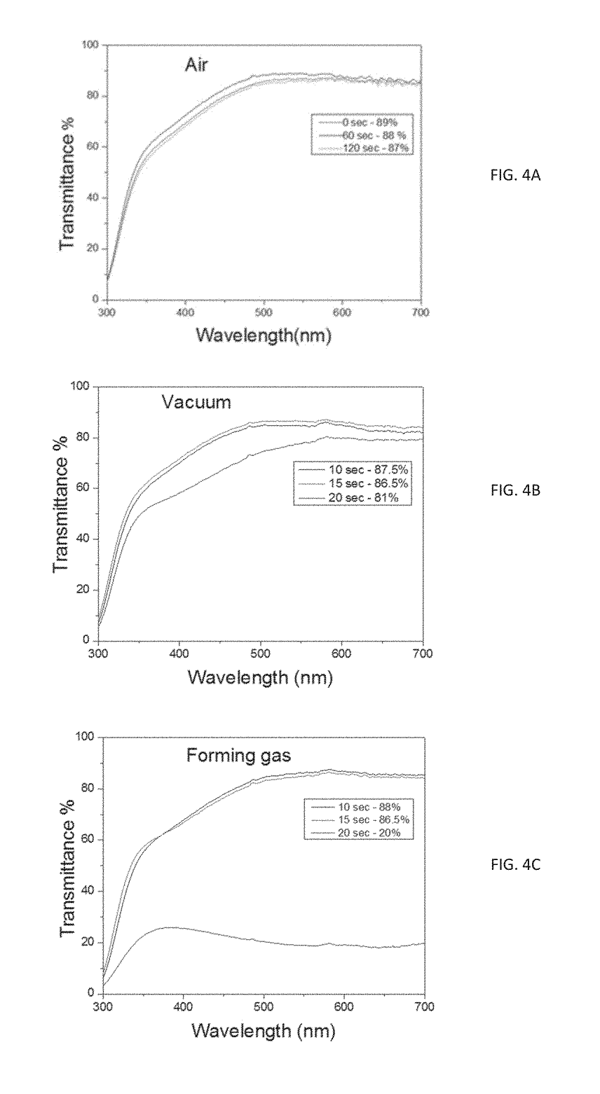

The curves representing optical transmittance of the same samples are plotted in FIGS. 4A, 4B, 4C. The results presented in FIG. 4A indicate that in ambient air atmosphere, the transmittance is maintained between about 88.5 and about 90%, which is highly desirable for commercial use. Under vacuum and forming gas environments, the optical transmittance value drops, which can possibly be attributed to the sparking inside the ampules leading to the ablation of the samples. A color change of the samples from clear to dark brown was observed as a result of such ablation (see also FIGS. 10A, 10B). The color change indicated that the ITO layer was burnt, which may explain the observed drop in optical transparency and increase in sheet resistance values within a short interval of time. Due to this reason, no further characterization of these microwave-annealed samples with XRD and AFM was performed.

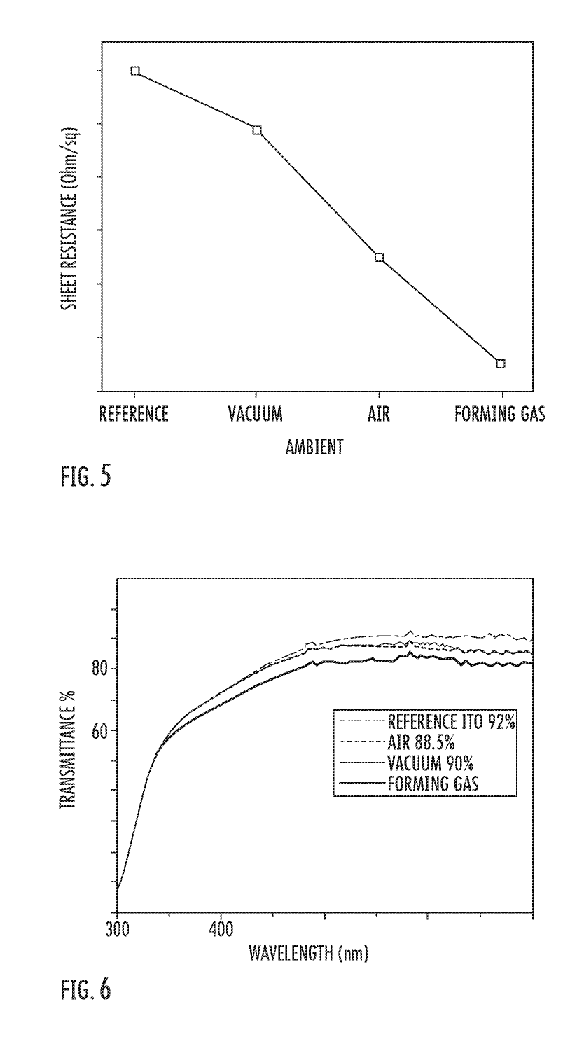

The electrical and optical properties of the laser-annealed samples are summarized, respectively, in FIGS. 5 and 6. As follows from FIG. 5, as a result of laser annealing of the ITO thin-film, the sheet resistance value of the ITO samples was substantially reduced as compared with the reference, not-annealed sample that showed a sheet resistance value of 2.70 Ω-cm. The annealed samples showed a drop in the resistance from 2.70 Ω-cm to 2.16 Ω-cm, 2.35 Ω-cm and 2.59 Ω-cm when annealed in forming gas, ambient air atmosphere, and vacuum, respectively. FIG. 6 evidences that there was observed a slight reduction in optical transmittance from about 92% in the reference ITO sample to about 90% (in samples annealed in vacuum and ambient air atmospheres), and to about 86.5% for samples annealed in the forming gas atmosphere.

To assess the result of annealing for the samples annealed with microwaves with those annealed with laser radiation, specific figures of merit (FOMs) were chosen according to conventions used in related art and compared with one another in light of how well the structural integrity of TCO samples was preserved as a result of annealing.

Figures of Merit.

The first FOM, known as a Fraser and Cook FOM, is defined as

Φ_{FC}=T/R_{SH} (2)

where T is the value of optical transmittance and R_{SH} is a value of sheet resistance. The second FOM is defined as

Φ_{H}=T¹⁰/R_{SH} (3)

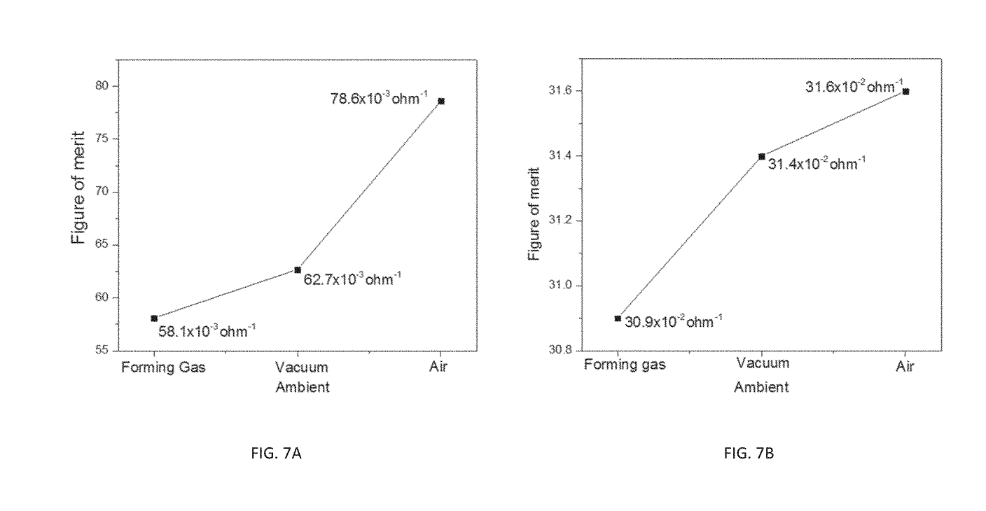

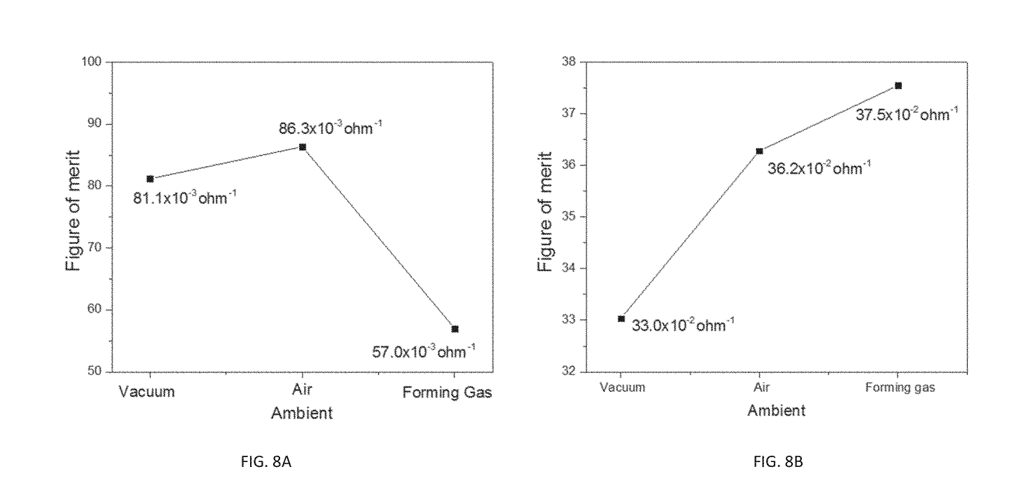

and is known as a Haacker FOM. The Φ_{H} FOM makes more emphasis on optical transparency characteristic. FIGS. 7A, 7B illustrate the changes of the values of Φ_{H} and Φ_{FC}, respectively, observed in the case of microwave annealing of the ITO samples. FIGS. 8A, 8B illustrates the changes of the same FOMs observed in the case of laser annealing of the substantially identical ITO samples for the optical transmittance values maintained in the range between about 85% and 90%. (Using identical transmission and sheet resistance data, a person of skill in the art can compare various FOMs. Based on the film transmission of 95% and a sheet resistance of 10 Ohms/square, which is reasonable for most high-quality transparent conducting films, the FOM of about or greater than 0.1 typically represents desirable film properties.)

Surface Morphology and Ablation.

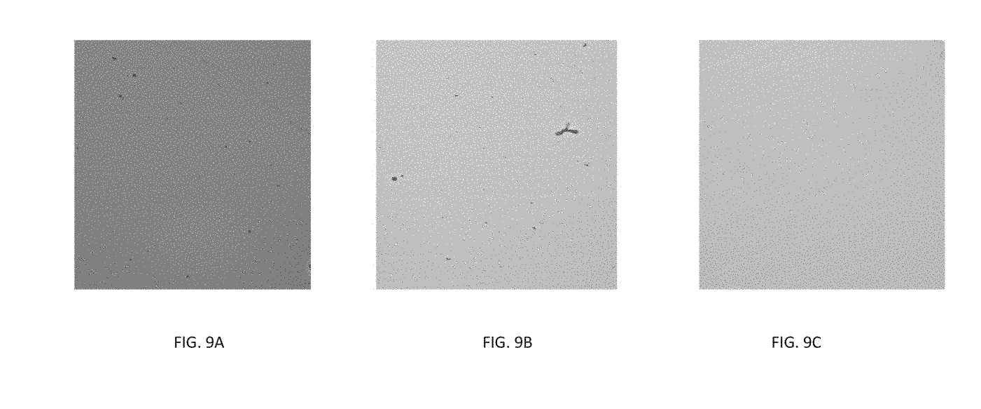

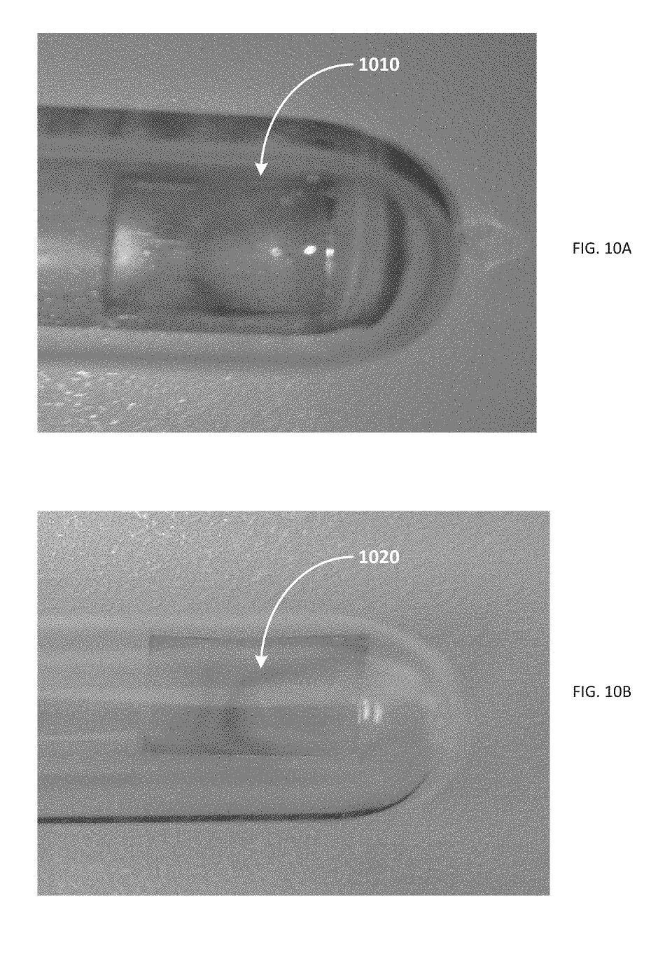

At the same time, structural modification of the surface of a sample caused by annealing was assessed both with the use of an optical microscope (by acquiring images illustrating whether the annealing was accompanied with ablation of the sample) and the AFM. The images of the surface of the laser-annealed TCO samples are presented in FIGS. 9A, 9B, 9C (for the ambient air, forming gas, and vacuum atmosphere, respectively) and provide visually-perceivable representation of substantial lack of annealing of the surface of the TCO samples. In comparison, FIGS. 10A, 10B present images of the TC) thin-films, deposited on appropriate substrates, which have been burnt/delaminated (see 1010, 1020) from the substrates as a result of microwave-annealing-caused plasma discharge.

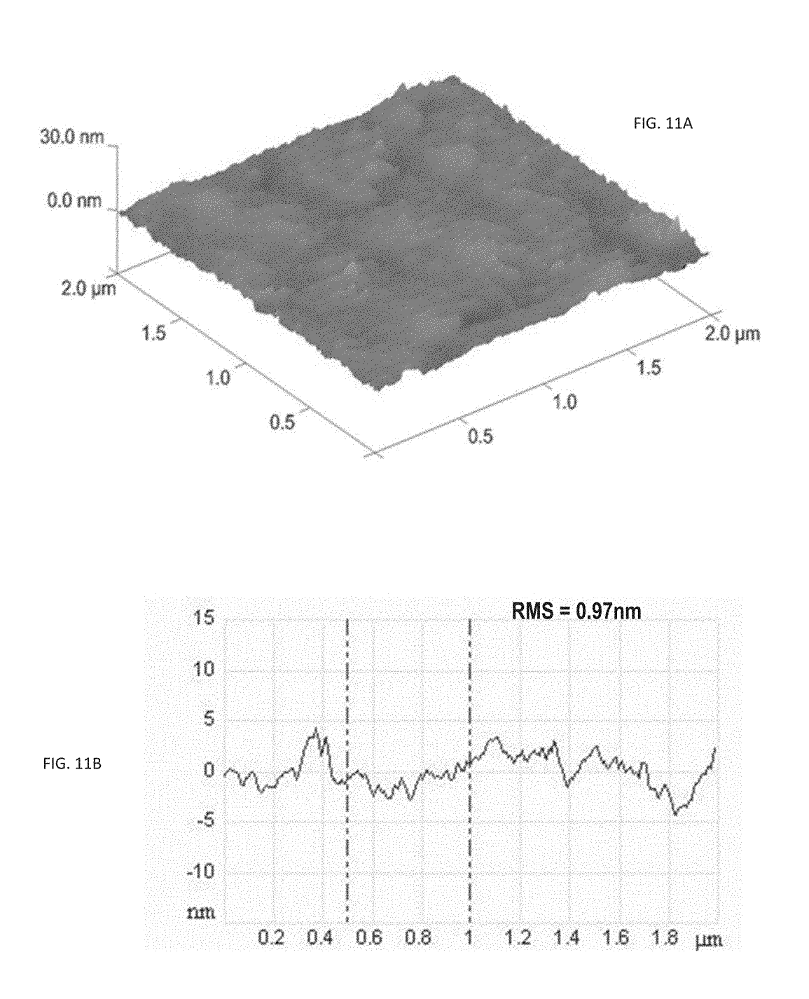

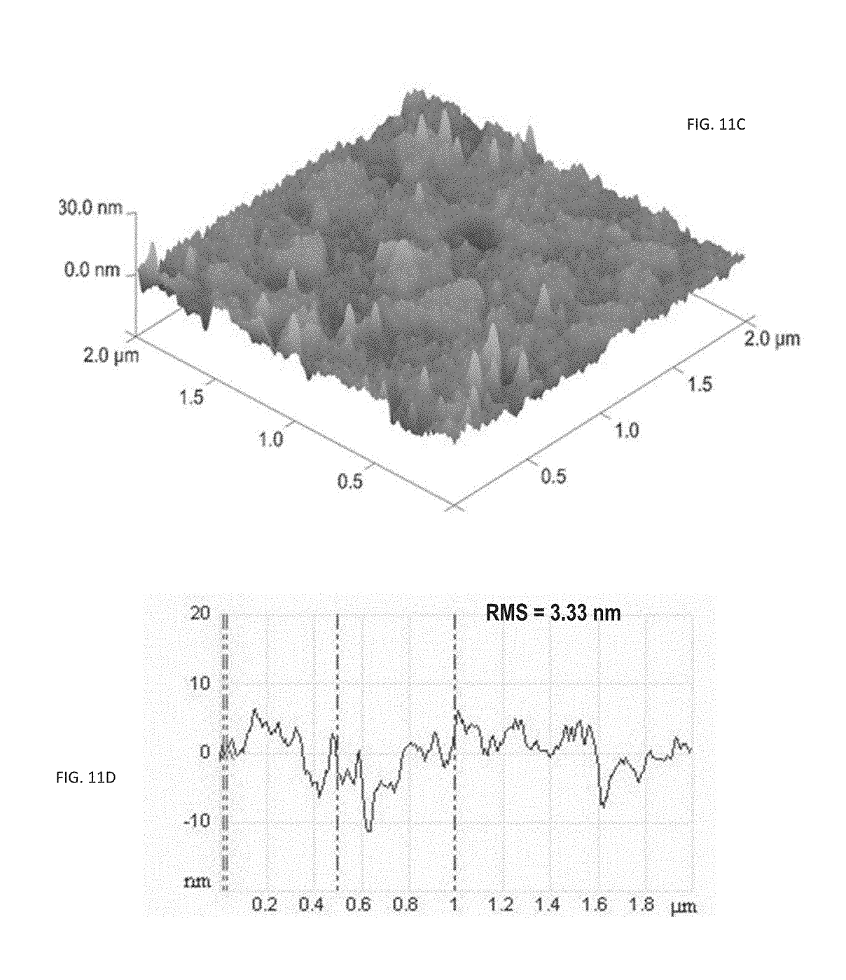

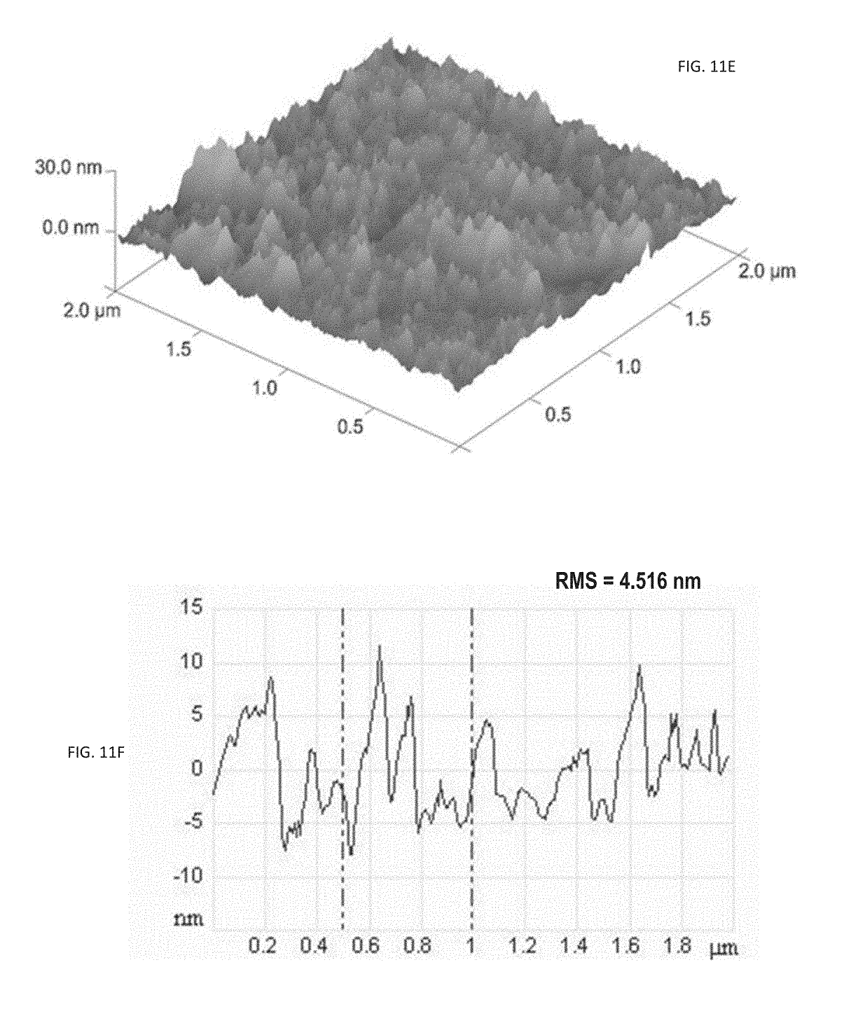

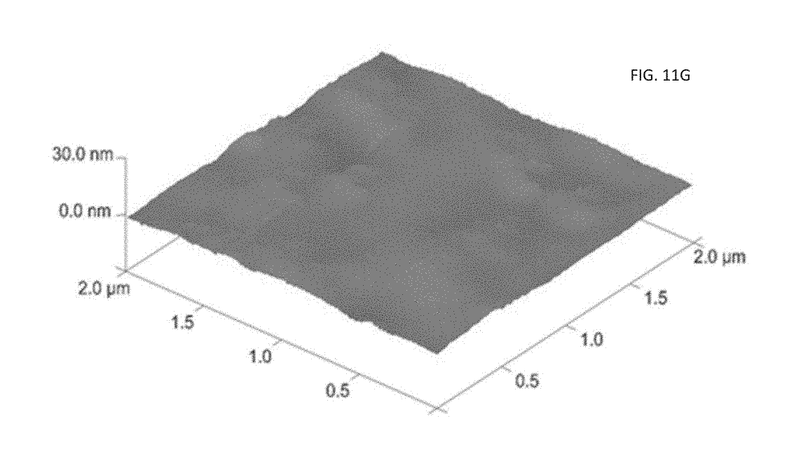

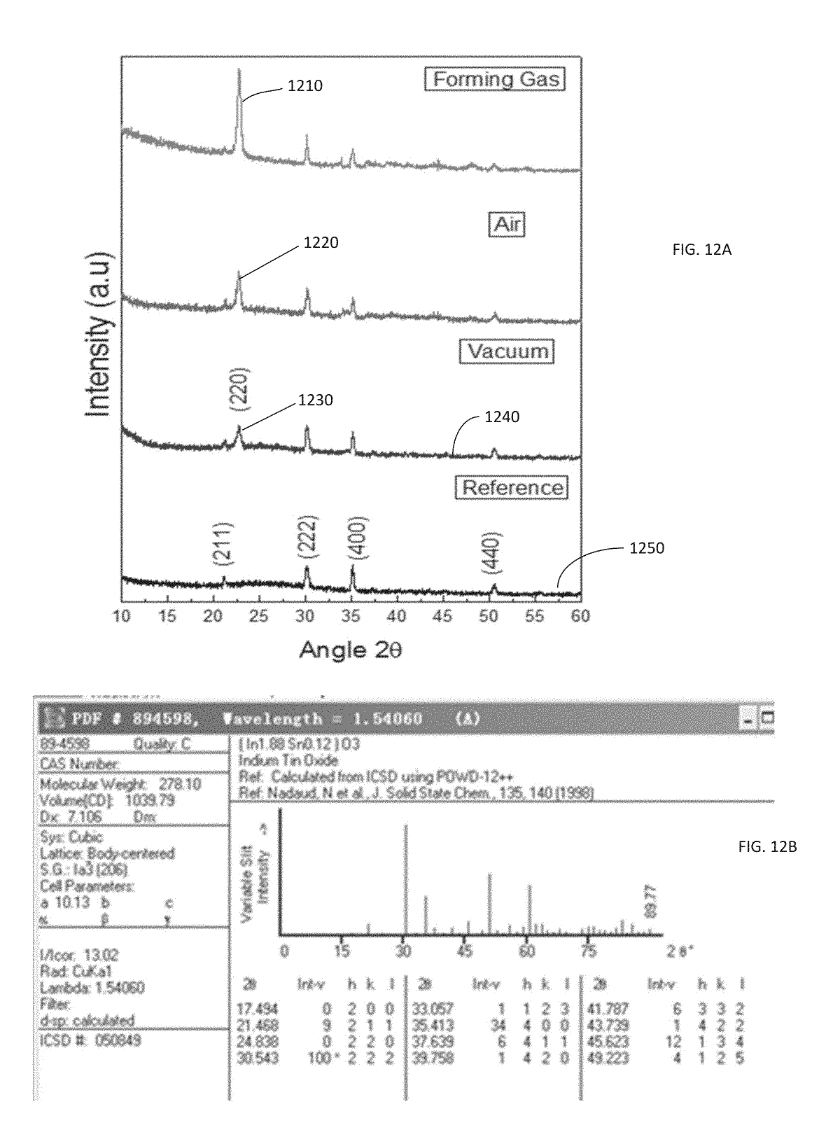

AFM images of the laser-annealed TCO samples and corresponding curves representing surface profiles are presented in FIGS. 11A, 11B, 11C, 11D, 11E, and 11F. For comparison, the AFM image of the initial (not annealed yet) TCO sample is shown in FIG. 11G.

Notably, the laser annealing in the forming gas atmosphere is proven to modify the surface morphology of the TCO sample the least, both in terms of the resulting rms surface roughness and the lack of ablation. According to the idea of the invention and despite the fact that the Φ_{H} value for the laser annealing in the forming gas was measured to be lower than that for the microwave annealing case (compare FIGS. 7A and 8A, which may indicate to a skilled artisan that the microwave annealing may be preferred in terms of preservation of the optical transparency and reduction of the sheet resistance of the sample), the minimized modification of the surface morphology was chosen to be the preferred outcome of annealing procedure. Accordingly, the laser annealing of the TCO was chosen over the microwave annealing.

The results of X-ray Diffractions Measurements of the laser-annealed TCO samples are shown with the four curves of FIG. 12A. The XRD analysis of the samples was carried out using Xpert PANalytical system. The crystalline structure and phase analysis of the synthesized samples were confirmed from the powder X-ray diffraction pattern. The data were plotted between the scattering angle 2θ ranging from 20°-60° and the intensity recorded in terms of counts per second. All diffraction peaks in the XRD pattern was referred, matched, and indexed with the standard JCPDS number 894598 corresponding to the ITO peaks. Three main peaks (211), (222), (400) were observed. These three peaks respectively correspond to the standard ITO peaks. Therefore, both in ambient air atmosphere and in forming gas atmosphere, there appears a substantial increase in the peak intensity as well as an extra peak (220) shown as 1210, 1220 in FIG. 12A. The appearance of the strong extra peaks 1210, 1220 evidences the formation of grain boundaries as a results of laser annealing. (The not-well defined extra peak 1230 of curve 1240, obtained in vacuum, may not necessarily suggest any prominent difference from that of the standard reference, curve 1250). XRD characterization data representing the standard reference, not annealed sample are summarized in FIG. 12B.

The assessment of the average increase in grain size was performed with the use of Debye-Scherer equation

$$D = \frac{K λ}{β cos θ} \qquad ( 5 )$$

where K=0.9, λ=0.154 nm, β is the value of intensity measured at full-width-at-half-maximum (FWHM) of the diffraction peak, and θ is the Bragg angle. The calculated grain dimensions are summarized in Table 1 in correspondence with the sheet resistance values, and demonstrate that the reduction in sheet-resistance of the TCO sample caused by laser annealing of the sample is accompanied by increased of a grain size and, therefore, by reduction of scatter of X-rays at the grain boundaries. The laser annealing in the forming gas atmosphere is preferred to that in ambient air and/or vacuum.

TABLE 1

| Ambient Condition | Grains Size | Sheet Resistance |
|---|---|---|
| Vacuum | 8.4 mm | 2.59 Ω/sq. |
| Air | 8.8 mm | 2.34 Ω/sq. |
| Forming Gas | 9.8 mm | 2.15 Ω/sq. |

To carry out the methodology of the invention, it may be required to employ a processor controlled by application-specific instructions stored in a tangible memory element. If such use of the processor is required, those skilled in the art should readily appreciate that required algorithmical functions, operations, and decisions may be implemented as computer program instructions, software, hardware, firmware or combinations thereof. Those skilled in the art should also readily appreciate that instructions or programs defining the functions and elements of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

Within this specification, embodiments have been described in a way that enables a clear and concise specification to be written, but it is intended and will be appreciated that embodiments may be variously combined or separated without parting from the scope of the invention. In particular, it will be appreciated that each of the features described herein is applicable to most if not all aspects of the invention.

In addition, when the present disclosure describes features of the invention with reference to corresponding drawings (in which like numbers represent the same or similar elements, wherever possible), the depicted structural elements are generally not to scale, for purposes of emphasis and understanding. It is to be understood that no single drawing is intended to support a complete description of all features of the invention. In other words, a given drawing is generally descriptive of only some, and not necessarily all, features of the invention. A given drawing and an associated portion of the disclosure containing a description referencing such drawing do not, generally, contain all elements of a particular view or all features that can be presented is this view, at least for purposes of simplifying the given drawing and discussion, and directing the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this particular detail in the drawing may be implied unless the context of the description requires otherwise. The described single features, structures, or characteristics of the invention may be combined in any suitable manner in one or more further embodiments.

The invention as recited in claims appended to this disclosure is intended to be assessed in light of the disclosure as a whole, including features disclosed in prior art to which reference is made.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

While the invention is described through the above-described examples of embodiments, it will be understood by those of ordinary skill in the art that modifications to, and variations of, the illustrated embodiments may be made without departing from the inventive concepts disclosed herein. Disclosed aspects, or portions of these aspects, may be combined in ways not listed above. Accordingly, the invention should not be viewed as being limited to the disclosed embodiment(s).

1. A method for modifying an electrical characteristic of a transparent conductive oxide (TCO) material, the method comprising:
exposing said material to chosen ambient conditions; and
irradiating said material with laser radiation under pre-determined conditions,
wherein the chosen ambient conditions include presence of one of forming gas, air, and vacuum.

2. A method according to claim 1, wherein said irradiating includes irradiating said material with infrared light.

3. A method according to claim 1, wherein said irradiating includes forming a focal point of a laser beam at said material.

4. A method according to claim 3, wherein said forming includes forming the focal point at a surface of said material.

5. A method according to claim 1, wherein said irradiating includes irradiating the material that is exposed to a mixture of nitrogen and hydrogen.

6. A method according to claim 5, wherein said irradiating includes irradiating the material exposed to said mixture in which content of hydrogen is between 0.01% and 20%.

7. A method according to claim 1, further comprising: as a result of said irradiating, forming an annealed TCO having a surface characterized by at least one of i) a root-mean-square roughness of 4.5 nm or lower; ii) a grain size of 8.5 nm or greater, and iii) a sheet resistance value of 2.59 Ohms per square or lower.

8. A method according to claim 1, further comprising:
configuring said material as a thin film; and
as a result of said irradiating, forming an annealed TCO characterized by a ratio, of a first value to a second value, that is greater than about 33*10⁻² Ohm⁻¹, wherein the first value is an optical transmittance of said thin optical film and the second value is a value of sheet resistance of said thin film.

9. A method according to claim 1, further comprising depositing a thin film of the TCO material on a substrate, and wherein said exposing and irradiation includes exposing and irradiating said thin film.

10. A method according to claim 1, wherein the irradiating includes forming an annealed TCO material in absence of ablating said TCO material.
